(19) United States
(12) Patent Application Publication
(10) Pub. No.: US 2022/0078006 A1
(43) Pub. Date: Mar. 10, 2022

(54) VERIFIABLE OBJECT STATE DATA TRACKING

(71) Applicant: Guardtime SA, Lausanne (CH)

(72) Inventors: Hema Krishnamurthy, Phoenix, AZ (US); Jamie Steiner, London (GB); Joosep Simm, Tallinn (EE); Janis Abele, Tallinn (EE)

(73) Assignee: Guardtime SA, Lausanne (CH)

(21) Appl. No.: 17/419,652

(22) PCT Filed: Dec. 31, 2019
(86) PCT No.: PCT/US2019/069121

§ 371 Date: Jun. 29, 2021

Related U.S. Application Data
(60) Provisional application No. 62/787,194, filed on Dec. 31, 2018.

(51) Int. Cl. H04L 9/08; G06F 21/64

(52) U.S. Cl. CPC H04L 9/088; G06F 21/64

(57) ABSTRACT

A method for auditably tracking data objects is proposed. The method comprises: in a first data structure (1000), aggregating inputs by rounds (Round 1, Round 9, Round 15) and, at the end of each corresponding round, computing a highest level value (root1, root9, root15) of the first data structure; at a position within the first data structure (1000) corresponding to a respective unique key (Ki) computed for each respective data object, setting as a respective input value an indication of which round during which a state value representing the respective data object was most recently changed; for each input of the first data structure that is changed during each round, storing in a second data structure (1100) an indication of during which previous round each respective changed input was most recently changed; and for each round, computing a representative value of the second data structure and storing the representative value as an input (1010) in the first data structure; whereby a change history of each data object may be determined by iteratively examining a state of the first data structure (1000) backwards in time according to the indications in the second data structure (1100) corresponding to the respective data object.

### CROSS-REFERENCE TO RELATED APPLICATIONS

This application claims priority of U.S. Provisional Patent Application No. 62/787,194, which was filed on 31 Dec. 2018.

### TECHNICAL FIELD

This invention relates in general to data security and in particular to verification of information stored in data structures.

### BACKGROUND

Data structures are of course used to store all manner of data elements and, often, to relate them to each other. In some cases, the data structure is meant to encode and record indications of events in some process, such as steps in a manufacturing process, or a supply chain, or even steps in a document-processing or business process. One common concern is then verification: How does one know with enough assurance what entity has created the data entered into the data structure, and how does one know that it hasn't been altered? In some cases, verifiable indication of timing and sequencing is also important, which adds additional complexity.

One method gaining in popularity is to encode event data, for example, by computing its hash value, possibly along with some user identifier such as a Public Key Infrastructure (PKI) key, and then to store this hashed information in a structure such as a blockchain with distributed consensus and some proof-of-work arrangement to determine a “correct” state of the blockchain and which entity may update it. Many of the blockchains used for cryptocurrencies follow this model, for example, since they, usually by design philosophy, wish to avoid any central authority. Such arrangements suffer from the well-known “double spending” problem, however, and are even otherwise often unsuitable for entities such as governments, banks, insurance companies, manufacturing industries, enterprises, etc., that do not want or need to rely on distributed, unknown entities for consensus.

Several different time-stamping routines and services are available that are good at proving the time that data was signed, and that the data being verified is the same as the data that was presented at some point in the past. These systems typically suffer from one or more if at least the following weaknesses:
The same data can be signed at different times, and therefore, the presence of a signature does not preclude the existence of another, earlier, signature for the same data (or, indeed, a later signature). For use cases where ownership should be proven, this is inconvenient. This may be viewed as a “uniqueness” problem.
A digital signature does not prove the uniqueness of the thing being signed. Therefore, it is possible to produce many simultaneous signatures on alternate versions of a thing, and later it cannot, without additional measures. be proven which one was valid. This is a “parallel history” problem.
It is in many cases not possible for a user to attest or commit to a particular value, representing a decision or state, as he could always choose to sign other values, and simply hide them if preferred. This leads to the problem of “negative proof”.
As a somewhat separate issue, there are cases where one might want to reduce the level of trust required in the operator of the signature service.

Because of the such constraints, it follows that it is not always possible to use known timestamping services to prove that a particular sequence of events occurred in a particular, correct, or otherwise desirable order, because another sequence of events could also have received signatures, and simply be hidden from view. It also follows that it may also not always be possible to define what the correct/acceptable order of events should be, because such a definition would have to exist as a unique, addressable specification for a process.

In general, as more and more services—both public and private—are performed digitally, the need for a mechanism to ensure trustworthiness of the underlying processes also grows.

### BRIEF DESCRIPTION OF THE DRAWINGS

FIG. 1 illustrates data structures in one example of a verifiable Log-Backed Map (VLBM) in the data structure verification (DSV) system disclosed herein.

FIG. 2 illustrates how the VLBM may encode the state and state changes of a process.

FIG. 3 illustrates the functional relationship between VLBM components shown in FIG. 1.

FIG. 4 shows how multiple, per-client DSV instances may be “stacked”.

FIG. 5 illustrates a “lopsided” Merkle tree.

FIGS. 6 and 7 illustrate different aspects of a skip list.

FIG. 8A illustrates a 1-2 skip list and FIG. 8B illustrates a corresponding 2-3 tree.

FIGS. 9A-90 illustrate the structure and principles of a Sparse Merkle Tree (SMT).

FIGS. 10A-10D illustrate a Verifiable Log of Registry Changes (VLORC).

### DETAILED DESCRIPTION

Disclosed here is an arrangement for data structure verification (referred to generally as the “DSV system” or simply “DSV”) that addresses the issues mentioned above.

Among many others, DSV lends itself well to use cases such as:
Providers of a service platform may wish to prove to users that it has followed the agreed service process
A governmental entity may wish to be able to prove that it has followed proper procedure for processing applications for the grant of some benefit
Mortgage or title registry, where a document must exist “in one copy only”
eVAT wherein one must prove that both buyer and sellers of goods, plus the appropriate tax authority, all agree on a particular sequence of facts being reported with respect to VAT collection for a given shipment of goods. A further assumption may even be that the tax authority employees themselves cannot be trusted to keep records honestly—they might delete records, etc.)
A university diploma registry where one must prove that a diploma has been reviewed according to a specified process, and all the appropriate authorities have agreed to the authenticity of a provided document. Additionally, it may be desired to be able to see a complete list of all diplomas issued and/or a complete list of permissions given to stakeholders over time. Such a proof should be able to be verified by employers, etc., and reliance on it should be cryptographically sound.

These use cases, which are of course simply a few of the many possible ones, share common features: There is a need to provide a registry of users, and bind them digitally to an authorized identity (User Registry). A “registry” may be any data structure that can store digital representations of whatever items (which themselves may already be in digital form) are to be tracked. Examples are given below.

Further, in many cases Users (any entity that creates data that is to verifiably included in the data structure) should hold a particular role or office or other authorization level, at the time of their authorization (CEO of company, member of tax authority, current owner of mortgage). Therefore there is often a requirement to maintain an organizational or hierarchical registry, and be able to prove membership, change membership (joining or leaving a company, for example), revoke and add keys, etc., so that it is possible to construct a practical system that can accomplish the above using signatures, if those signatures are based on a private key of some kind. These features are not universal however, and other use cases will have other characteristics, although the assumption is that some process is to be made verifiable.

Embodiments may be used to verifiably track any type of object—even abstract items such as steps in a chain of decisions—that can be identified, represented, or encoded in digital form. The “state” of the object may be defined in any chosen manner. In general, it will be a digital representation of at least one aspect of the object to be followed. For example, a document, possibly plus metadata, could be represented as a hash of all of part of its contents. The metadata could include such information as who is its current owner/administrator, time, codes indicating rules such as permissions, indications of decisions, etc., and/or any other information a system administrator wishes to include. In a manufacturing process, information such as unit or part IDs, digital codes assigned to the different manufacturing stations or processing steps, measurements of characteristics, shipping location, etc., could be represented digitally and form an object that may change over time. For abstract objects such as a chain of decisions, identifiers of the decision-makes, indications of times and of the respective decisions, notations, etc., could be encoded digitally in any known manner and entered into a registry and tracked.

As used here, a process is a series of actions or steps taken in order to achieve an end. Some simple examples of processes are: issuing a certificate/document; amending property ownership records or a list of voter registrations; and a series of manufacturing steps to create a product. There are of course countless other processes that comprise a series of actions or steps.

Processes may be defined as states and transitions, that is, changes of those states. For example, the state of a document might be “unauthorized” or “authorized”, and some user action may cause the state of the document to change from the one to the other. Transitions may be caused not only by intentional user action, but may also occur automatically or even naturally.

The state of something may not be the only thing a user needs to be able to trust. Consider, for example, a will, that is, a last testament. A registry might be set up to record the existence of a will, but the representative of a testator, or of a probate court, may also want to know when the state of that will was most recently changed (to be sure the testator was still competent at the time) such as being amended or replaced by a new will, what any previous and superseded version was, and also that no other valid wills by the same testator exist, which requires some method for proof on nonexistence. It may also be necessary to be able to prove that the registry itself is performing correctly.

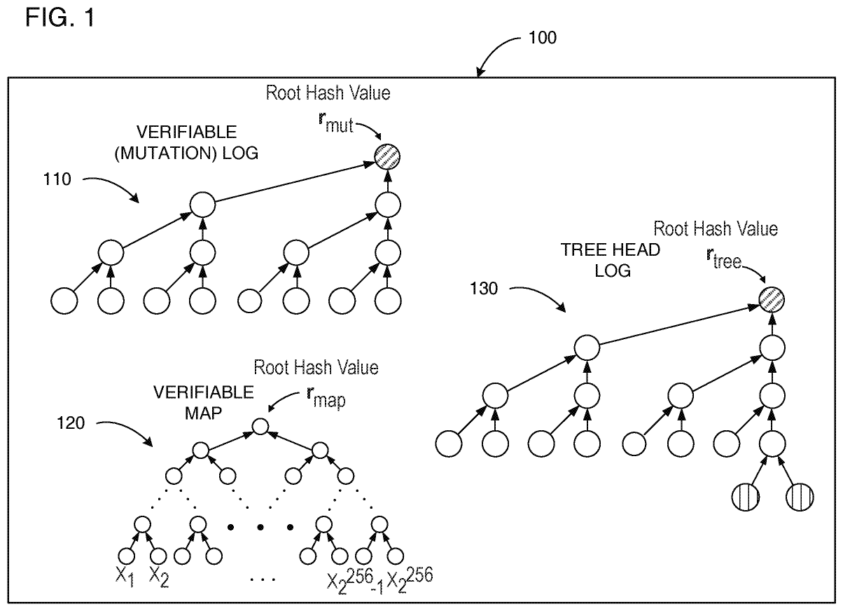

FIG. 1 illustrates three component data structures which, in one embodiment, cooperate to form a verifiable Log-Backed Map (VLBM) 100: a Verifiable (Mutation log) State Tree 110; b) a Verifiable Map 120; and c) a Tree Head Log 130. These are described further below.

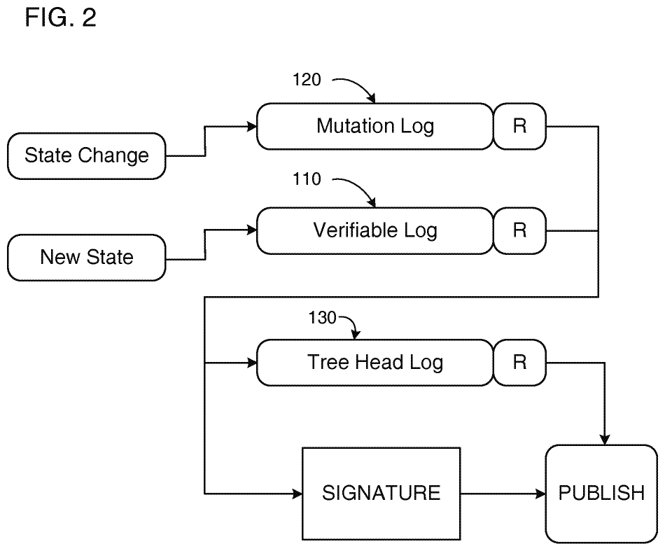

FIG. 2 illustrates, at a high level, the use of the structures of FIG. 1 to verifiably encode the state and state changes of a process. Here, “R” indicates the root value of a respective hash tree included in each component of the system shown in FIG. 1.

### Digital Signatures and Timestamping

Several methods are known for digitally signing and/or timestamping data. In general, the system designer who wishes to implement embodiments of this invention may use any preferred and such system, or systems (for example, separate systems for generating signatures and for timestamping). Nonetheless, by way of example, the Guardtime KSI® system is referred to herein and preferred because of its advantages, one of which is that it is able to generate digital signatures for data that also serve as irrefutable timestamps. Other signature solutions may also be used, however, although they should be able to perform the same functions. The Guardtime KSI® system will now be summarized for the sake of completeness.

### Guardtime KSI®

Guardtime AS of Tallinn, Estonia, has created a data signature infrastructure developed and marketed under the name KSI® that also includes a concept of “blockchain” that does not presuppose unknown entities operating in a permissionless environment. This system is described in general in U.S. Pat. No. 8,719,576 (also Buldas, et al., “Document verification with distributed calendar infrastructure”). In summary, for each of a sequence of calendar periods (typically related one-to-one with physical time units, such as one second), the Guardtime infrastructure takes digital input records of any type as inputs. These are then cryptographically hashed together in an iterative, preferably (but not necessarily) binary hash tree, ultimately yielding an uppermost hash value (a “calendar value”) that encodes information in all the input records. To this point, the KSI system resembles a typical Merkle tree. This uppermost hash value is however then entered into a “calendar”, which is structured as a form of blockchain in the sense that it directly encodes or is otherwise cryptographically linked (for example, via a Merkle tree to a yet higher root value) to a function of at least one previous calendar value. The KSI system then may return a signature in the form of a vector, including, among other data, the values of sibling nodes in the hash tree that enable recomputation of the respective calendar value if a purported copy of the corresponding original input record is in fact identical to the original input record.

As long as it is formatted according to specification, almost any set of data, including concatenation or other combination of multiple input parameters, may be submitted as the digital input records, which do not even have to comprise the same parameters. One advantage of the KSI system is that each calendar block, and thus each signature generated in the respective calendar time period, has an irrefutable relationship to the time the block was created. In other words, a KSI signature also acts as an irrefutable timestamp, since the signature itself encodes time to within the precision of the calendar period.

One other advantage of using a Guardtime infrastructure to timestamp data is that there is no need to store and maintain public/private (such as PKI) key pairs—the Guardtime system may be configured to be totally keyless except possibly for the purposes of identifying users or as temporary measures in implementations in which calendar values are combined in a Merkle tree structure for irrefutable publication in a physical or digital medium (which may even be a different blockchain). Another advantage is less apparent: Given the signature vector for a current, user-presented data record and knowledge of the hash function used in the hash tree, an entity may be able to verify (through hash computations as indicated by the signature vector) that a “candidate” record is correct even without having to access the signature/timestamping system at all.

Yet another advantage of the Guardtime infrastructure is that the digital input records that are submitted to the infrastructure for signature/timestamping do not need to be the “raw” data; rather, in most implementations, the raw data is optionally combined with other input information (for example, input server ID, user ID, location, etc.) and then hashed. Given the nature of cryptographic hash functions, what gets input into the KSI system, and thus ultimately into the calendar blockchain, cannot be reconstructed from the hash, or from what is entered into the calendar blockchain.

If used in this embodiment of the DSV system, the KSI (or other chosen) system is preferably augmented with additional capability, which provides the following additional properties:
A customer should be able cryptographically commit to a particular value. The value should be addressable using a unique key, which the customer may share, without revealing the value, and later it should be provable that this key did not have any other value at a given time. This will solve the uniqueness and negative proof problems. Note that “key” is not used here in the sense of PKI, but rather in the more general cryptographic sense, which includes values (encrypted or otherwise) used to index or reference into a table or other data structure. In many embodiments here, the key is a value derived in any chosen manner (such as by hashing) based on any information that identifies a data object and associates it and its relevant content with a position (such as a lowest level “leaf” value in a data structure such as a hash tree, in particular a sparse Merkle tree.
The value for a particular key should be mutable over time, but such that there should be no way for a server to construct alternate proofs for a given key, which would indicate that the key had two different values at any particular time, without it being detected. This addresses the parallel history problem.
A user should preferably be able to define and specify what is a valid manner to proceed in the process; that is, the value should preferably be mutated only according to a predefined set of rules. If implemented, these rules should preferably be cryptographically linked to the unique key which addresses the value. In this way, one may verify that these predefined rules were followed correctly, based on information contained in the proof.
A user or auditor should preferably be able to audit the server that provides these proofs, such that any attempt by the server to construct parallel histories can be detected. While full audit of the history may be required, the audit should preferably be as practical as possible.
A user of the system should preferably be able to compare proofs with other users, so that inconsistent behavior may be detected by the service provider/server. If detected, it should preferably be possible to reliably inform other users as soon as possible, and not be prevented from doing so by the service provider.
The KSI signature vector, or a similar vector of values that identify sibling values in a Merkle tree from a chosen input level up to the tree root, especially if that root itself is verifiable, is one form of “proof”.

As with most blockchain technologies, it is desirable to make sure the system continues to operate correctly even when a central party is misbehaving (perhaps due to malice, corrupt employees, incompetence or, for example, hacking). The aim of the particular design is generally to see to it that the worst the central system administrator or operator can do is to turn off various parts of the system—which will be obvious to system users—but the central operator at least cannot make the system “tell a lie” without eventually being found out (hopefully quickly, e.g. within minutes or seconds).

The main principle of DSV operation is that all state changes happen as a consequence of events (“transactions”). An event might be for example “User 1 sends $10 to User 2”, or “tax office rejects claim #321”; the system may guarantee that all users will eventually agree on the exact sequence of these events (even if the central operator cheats), and thus everyone can compute correctly all the state/outputs of the system (e.g. “User 1 now has 30 dollars”). The events may be digitally signed by their originators, thus ensuring that the central operator cannot forge events.

As a typical speed optimization, the latest state may be kept by the central operator as well, in a special structure called “state tree”. Options for implementing such a state tree are presented below.

Note that both events and the resulting state may be “sharded” so that users see only events and states that they are allowed to see, but nonetheless can verify the completeness and correctness of their own data. To this end, in one embodiment, the DSV system preferably includes a “gossip” mechanism for published information, that is, for information entered into some medium that is, in practice, immutable and irrefutable. See, for example, https://en.wikipedia.org/wiki/Gossip_rotocol for a summary of “gossiping” in this context.

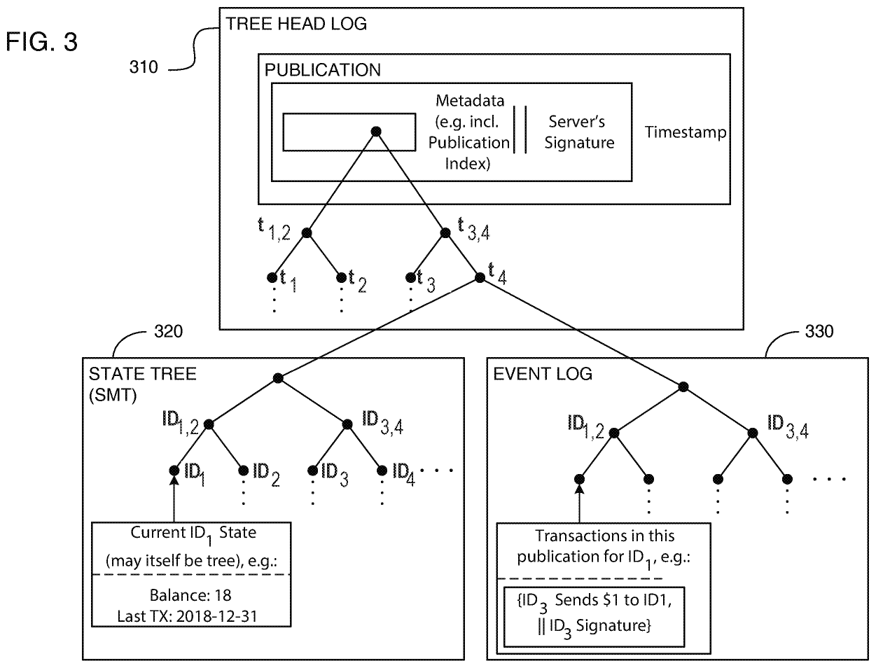

FIG. 3 illustrates the functional relationship between the three components shown in FIG. 1. “Dots” of a “parent” node in the respective components' hash trees represent the results of hashing the values of the “child” nodes. In FIG. 3, “ID” indicates a channel or input “leaf” assigned to entity or object i, not necessarily the data that Userᵢ may from time to time enter into the respective hash (Merkle) tree. The data associated with the node labeled ID_{1,2} is the hash of the data associated with nodes labeled ID₁ and ID₂, and so on. In general, ID_{x,y} is used to indicate the value derived by binary (or other degree) hashing of all the leaves from IDₓ to ID_{y}. Note that cryptographic hash function are not commutative and the order of hashing shown in this disclosure is just one choice; those skilled in data security understand well how to reorder parameters of a hash function to produce consistent and correct equivalent results.

In short, the DSV system periodically, during a series of “aggregation rounds”, collects all new events (for example, all completed manufacturing steps in the last hour, currency transfers in the last second, etc.) and aggregates them all into its Event Log Merkle (hash) tree 330. The resulting state changes may then be represented in the State Tree 320, which may be configured as a sparse Merkle tree (SMT)—for example, every account could have its latest balance in there, potentially with history and various metadata. The root values of the Event Log hash tree and the SMT may then be aggregated (for example, during each of some predetermined aggregation period) into a history tree (called here a “Tree Head Log” 310 (such as the log 130 in Figure. The root of the Tree Head Log may be periodically signed by the central operator and that signature is potentially timestamped. A KSI signature may, as mentioned above, itself encode time. The resulting signed hash value may then optionally be “gossiped”, that is, distributed, to all or some other users to make sure they are all seeing the same view of the events and their results.

“Gossiping” may also be achieved via anchoring to other blockchains and other means; various optimizations also apply—e.g., the clients need to keep only the latest publication, plus its underlying data. Events from the past will generally also be needed for re-verification, some of that data may be selectively re-downloaded from the server as needed.

Note that, in the general case, if publication occurs every second, this would result in roughly 30 million publications per year; thus, a verifier would need have at least 30 million hash paths per year (and these can be different hash paths per each user), even if there are no events for that user (because the verifier needs to double-check the claim that there are no events, for each and every publication) There are several ways to optimize this for special scenarios (see below), for example, zero-knowledge proofs, including the idea of additionally also gossiping the hashed transactions per every user, in various sizes of gossip circles.

In FIG. 3, it is assumed that each privacy circle/channel is labeled with an “ID” (e.g. ID₁, ID₂, . . . ), so, for example, one user can see the data marked for “ID₁” and another user can see data marked for “ID₂”, etc. Theoretically, there can be more complicated markings with special indexes, where some datasets are marked with multiple IDs (e.g., some transactions may have to be visible to auditors to be valid, no matter which user the transaction belongs to, etc., so it could be labeled with 2 or more labels); FIG. 3 does not illustrate such a case merely for the sake of simplicity.

The Event Log represents events for each ID under the given publication round. It forms a verifiable map, mapping from a (hash of) ID to a hash of lists of transactions for a given ID. That list of transactions may be a tree itself, or it could be a simple list. In a typical blockchain use-case, the transactions may be signed by their authors; however, one could skip the signature if, for example, the transaction was authored by the central server in which the various data structures are implemented.

For privacy, every user may be constrained to download only tree paths that are for their IDs and that they are allowed to see; and yet users may still see that they have a complete list of transactions for their IDs (a proof of “non-inclusion” as well as “inclusion”).

The State Tree's Merkle tree shows the latest state in a given round after applying all events of the round. For example, every user could have its latest account balances there. For privacy and efficiency, this tree may also be “sharded” by IDs, and various state keys and values (for a specific ID) may also be represented as their own tree whose root may be included in the state tree for the given ID.

The Tree Head Log, which may also be viewed as a “history tree”, stores preferably all roots of the other trees for all publication times. Compared to a typical blockchain design, this history tree gives much shorter proofs for data under previous publications when starting from a more recent publication as a trust anchor.

For increased privacy, the nodes of the above trees may be built such that every node, or some set of nodes, is provided with one or more fake sibling nodes, in order to hide whether or not there is a different branch in the tree. It may then be possible to hide the fact that, for example, a particular entity is a customer; otherwise, a company whose name shares a large enough prefix with that customer would be able to see that there are no branches in the tree that can refer to.

The DSV system addresses several challenges, which include:

Efficiently Verifying Correct Operation

It is desirable to be able to efficiently prove/verify that the log-backed map is internally consistent (that, starting from an empty map and applying all mutations listed in the log, one arrives at the current state of the map). This challenge may be met by the following:
Regular users execute the state transitions (transactions) that they are shown by the central administrative server (for which the server provides proof of existence). Some users/auditors may also be able to re-execute all transactions (that they are allowed to see) from the beginning of the mutation log, which would, however, require the transactions to be deterministic. It would also be possible to use a trusted set of validators, who are authorized to see the private data.
Zero-knowledge proofs to prove correct operation of the log server

Proof that there were No Changes in the Given Time Period

The term “process ID” (shown as ID) below is used to refer to (the name of) a private channel of communication, usually with restricted access. For example, in a bank, every account could have its own process ID; this way, revealing information about one account (one “process”) does not require revealing information about any other account.

Problem: It takes a lot of time for an auditor to perform a full scan of the entire history (essentially, checking all published hashes ever, and for each of them, all hash paths underneath) to ensure the DSV server didn't behave maliciously. This can be mitigated by:
Zero-knowledge proofs—These are slower, but will guarantee that the server performed only the intended operations, without revealing transaction hash patterns.
Publish affected process IDs with every published root hash.—With this scheme, if the server fails to properly publish a process ID, then by definition, the system must act as if a particular process ID was not affected by the underlying updates, that is, the change announcement is part of the published root that is gossiped. For more privacy (to hide affected process IDs from public view) and potentially for less network traffic, the affected IDs may be aggregated into a SMT (every publication would have a new tree for this) and just publish its root hash. One disadvantage of this approach is that server would need to generate separate hash proofs for every user. Below, yet another mechanism—based on sparse Merkle trees—is described to enable more efficient determination of whether changes have occurred, and how to follow them.
Include a mechanism for declaring that time intervals for a given process ID are to be skipped. Some processes may need an update less frequently than the publication round, for example, only once per minute instead of once per second, or may not work at night, etc.
Clients can simply expect auditors to find such inconsistencies at some future date, which assumes that any data sent to the user is committed to a published root so that auditors will be able to see it.
Checkpointing—At predefined or random intervals, the auditor may sign and send out published hashes. The client could do the same (check the state) at different intervals (whether or not there is an auditor), and issue a notification if something is different from what the client knows to be correct. This reduces network traffic compared to everyone doing a full audit all the time (e.g., 1000 times less if the clients simply check every 1000th publication)
If hiding transaction patterns is not necessary, then the server may distribute proofs (preferably redacted, so private information is not sent) using the gossip mechanism: the central server publicly gossips transaction hashes (e.g., state transition hashes) by process ID—thus leaking the transaction patterns publicly. This will often be acceptable for many typical use cases, especially if the gossip channel is fast and scalable enough as far as the rest of the system is concerned. The channel used for gossip may, for example, be a public key of the central server, plus the unique process-ID. Clients may also gossip such redacted proofs on such a channel. Using this technique would allow parties who are interested in the given process ID to learn about changes to that process. Gossip messages should be valid, and therefore propagated by the network, only if they contain a valid server signature. While the server may collude with an attacker and produce a secret, non-authorized proof, when the attacker tries to use this proof to accomplish something bad, whichever entity it is shown to can gossip it, and wait for some other entity to gossip back a conflicting proof, and if it exists, the collusion of the server can be proven.

Not every user may always gossip with all other users about such proofs. For example, users of a lower-level DSV may be the only ones gossiping about transactions in their own DSV instance. This option may, nonetheless, be suitable in cases where entities wish the patterns of their DSV instances to remain private from the rest of the world, or where there is heavy traffic in the hands of small number of people, although both cases would typically be less secure due to a smaller number of nodes gossiping the data.

Prove No Split View

Again, to address this issue, there are alternative embodiments of a solution:
Publish Tree Head Log in an additional, different blockchain, for example, an external one, and use that to prevent split view
Use validators to gossip, although this would allow such validators to learn the transaction hash patterns of participating entities.
Gossiping of the root hash, signed by the server (for example, using a KSI signature). This solution requires no highly available validators. In this case, there may be a sequence number of that publication. This is possibly an optimization, since the gossiped publication data should also include an index number.
Gossip the root hash, which is also calculated from the data for all mutations. Mutations may also have backlinks to previous valid changes/mutations for modified keys. The backlinks may then help detect flip-flop attacks by the server. A flip-flop attack is a case wherein the server maliciously changes a state and then reverts it back. A legitimate user of the system will be unable to detect this, unless there are backlinks to every valid mutation which presents the entire history to the user.

In addition to the messaging techniques used to propagate gossip, the structure of the gossip message should be specified. The design of this message should support the goals of the gossip function, within DSV, namely, to allow users to efficiently audit the server, as it operates, and to detect split-view attacks, and other forms of incorrect operation.

Each Gossip may have two components, which are created at each publication interval:
1) pub/sub delivery of high level messages
2) a series of Supplemental Objects, which, together, form a constantly growing cryptographically linked data structure, which can optionally be downloaded, stored and audited (the “Audit Object”).

The pub/sub level gossip message should contain:
index number of gossip. All gossip messages should be numbered in monotonically increasing order.
new state root
server signature on this state root
content hash of a Supplemental Object, which, if one has the hash, can retrieve the object using a distributed content addressable file system. This technique assumes the existence of such a protocol.
server signature on the content hash

The Supplemental Object preferably contains:
THLog proof and THLEntry leading to the same new state root contained in the pub/sub gossip message (THL: Tree Head Log)
Array of Process Backlinks in the form ProcessID→last gossip index where ProcessID was changed. For every Map Leaf which was mutated in this period, there should be a link which indicates the gossip index at which time that Map Leaf was last changed.
Array of Content Hashes (Content Backlinks) to previous supplemental objects—further discussion below

Given this technique, parties who are interested in auditing would listen to the desired gossip channel and receive the published messages from the server. On their local machine, these parties should maintain an array of all ProcessID's and the index at which they were most recently updated. In order to participate in auditing, when the new gossip comes, they would:
1) Validate server signature on the state root
2) Validate server signature on the content hash
3) Retrieve the new Supplemental Object data
4) Check that the index has increased by 1. If it has increased by more than one, for example, due to being off-line, or due to network issues, they may then use the included array of Content Backlinks to retrieve the missing Supplemental Objects
5) Verify that proofs lead to root
6) Verify that Process Backlinks agree with currently cached array, that the indexes for all the processIDs that the gossip indicates were changed are indeed the most recent indexes in the cache.

7) If Process Backlinks agree, update the cache for the current batch of processID's, so that they are paired with the current index.

### Example Flipflop Attack

This describes a type of split-view attack, called a “flipflop”, in which the server makes an unauthorized change to a Process State, then changes it back, then tries to cover it up, by attempting to represent that the flipflop did not occur, and thereby conceal that the attack happened.
index 2: Process A is initiated
index 5: Process A is changed to state X, linking back to index 2
index 7: Process A is changed to state Y, linking back to index 5 (flipflop begins)
index 11: Process A is changed back to X, linking back to index 2

Assume that, between 7 and 11, there was an attack. Under the above proposal, when users receive and download the Supplemental Object for index 11, and double check their cache, following the procedure above, they will see that the cache indicates that Process A was most recently changed at index 5, not index 2, as indicated in the Supplemental Object.

They would then like to prepare evidence that the server has signed two conflicting statements, that is, the set of signed backlinks from index 7 and the object they just received at index 11.

Assume that the history of Supplemental Objects is not saved by this user, but is available on a content-addressable distributed file system. Object 11 is in their possession, but because they have not saved the object from index 7, they must retrieve it. This can be achieved using the Content Backlinks from object 11.

### Content Backlink Design

In one embodiment, where there was a single Content Backlink to the previous Supplemental Object, entities would need to walk the chain backwards from object 11, to 10, then 9, 8, 7.

This can be improved upon, to achieve O(log(n)) traversal of the Audit Object. A second, improved technique is to include not only the Content hash of the previous Supplemental Object, but also additional links to Supplemental Objects from older indices. In this way, each Supplemental Object contains an array to several older objects, with increasingly larger skips. For example: include Content Backlinks to the current index—1 (previous), current index—10 (ten old), current index—100 (100 old), current index—1000, and so on. This provides O(log(n)) traversal, that is, in order to walk back 2222 steps, you would only need to follow 8 steps, instead of 2222. Using this optimization, each traversal step requires a retrieval operation from the distributed content addressable file store, which will typically be slower than following a pointer in memory.

The problem with this approach is that the size of the Supplemental Objects increases greatly, and duplicates information. A further improvement may be made as follows:

Instead of including a large array of Content Backlinks in each Supplemental Object, most Supplemental Objects may contain only a single Content Backlink to their immediately prior objects. Then, at regular intervals, Sentinel Objects may be created, which contain a larger number of Content Backlinks. This can still be arranged to provide O(log(n)) traversal (albeit with a larger constant) but dramatically reduce the storage required for the Supplemental Objects. Additionally, since the position of these Sentinel Objects is known in advance, and their utility is high, there then exists an incentive for some users to replicate these Sentinel Objects, in order to assist the network in traversal requests.

### Namespaces and Multi-Level Hierarchies

The different “privacy circles”—called “process ID” in this document—may also be used as different “name spaces” for different services, customers, etc.

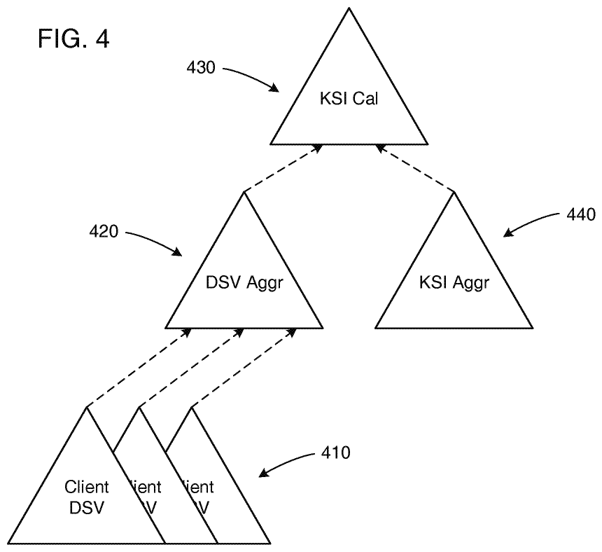

See FIG. 4, in which hash trees are represented as triangles, for simplicity. (This simplified representation is also used in other figures as well.) To provide more scalability, DSV instances may be stacked in a hierarchy, where the lower-level instances (Client DSVs 410) publish their tree head roots as leaves of higher level trees, and only the topmost tree's root is published into an external system such as a gossip mechanism, an external blockchain, such as the KSI calendar, etc. Such hierarchies may be built using many different configurations—for example, it would even be possible to mix of KSI and DSV aggregation trees (420, 440, respectively), or the top-level DSV aggregation tree's root could be entered as a leaf of a KSI aggregation tree. Some additional examples:

The hierarchies could be statically partitioned, for example, by geography, organization domain names, etc. On each level, or, for example, only on the bottom levels, actual process IDs with business data may be used. The topmost DSV may then contain the publications of different geographic continents; the next layer might contain continent-specific publications for industries (for example, health care, supply chain, etc.); and the layer under these might contain publications for organizations (for example, Company ABC, Bank XYZ, etc.), under which they would each store with their respective Process IDs. Thus, every company would have its own DSV instance on the bottom level.

The configuration may also be dynamic—as DSV supports smart contracts, there could be specialized smart contracts (with proper permissioning) to handle exactly where in the hierarchy one would find specific process IDs, and their positions could change over time, for example, to share loads across servers, etc.

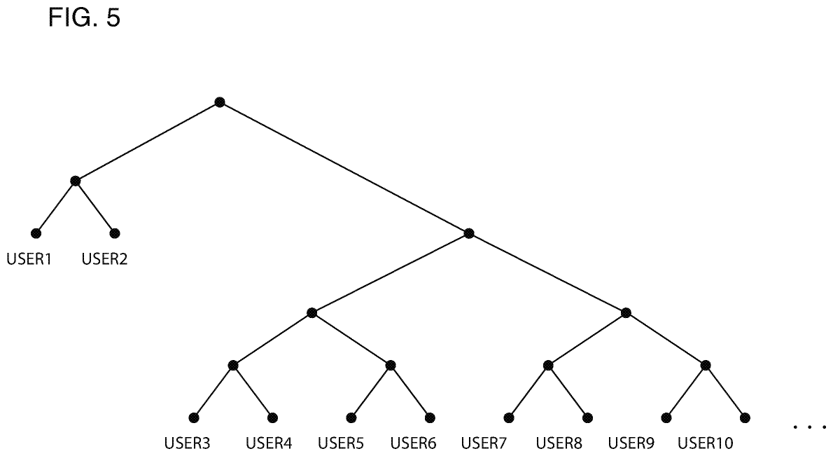

As FIG. 5 illustrates, this may be used to, for example, create a “lopsided” Merkle tree on purpose, giving very short hash paths to some specific customers who, for example, need a low network throughput. Taken to extreme, channels (hash tree leaves) for “high-profile” events or or high-value entities could even be included straight inside the gossiped top publications. Usually though, they will be somewhere lower in the top tree, or in any other included tree (but generally higher than the lowest leaves). As auditing Merkle-tree based histories always requires downloading many hash paths, this could reduce network traffic, as well as reduce the load on any verifying entity.

The various hash trees do not have to be binary, including the tree of FIG. 5; rather, they may be trees of degree n (ternary trees, quaternary trees, etc.), linked lists, such as common blockchains, etc. Furthermore, some (or all) parts of a hash tree could be replaced by various other constructs such as cryptographic accumulators, Bloom filters, different hash functions in different parts of the tree, etc. Such variations would enable dynamic changes in the way in which the data belonging to a DSV instance is authenticated.

A smart contract could be hard-coded into verifiers, or it could be upgradable “in flight” by a permissioning scheme, etc. The contract could be very simple. A degenerate case would be just a listing of processes that have to be in a specific place in a tree, with a default location by name for every other process, or they could be more complex, such as a smart contract that dynamically determines the location of items in the tree based on a real-time bidding market. Since any updates to the functioning of the such a smart contract need to be known to every verifier, care needs to be taken to ensure that the updates to the smart contract itself are verified and transmitted in an efficient manner.

All the above mechanisms of efficiency may still apply—for example, checkpointing could be used to ensure that the smart contract could only be updated once every hour/day/etc., and the updates could be of limited size and may even be limited by number of operations they are allowed to execute, thereby reducing the need to download a big number of updates to the smart contract itself.

### Use of Alternate Data Structures Such as Skip Lists

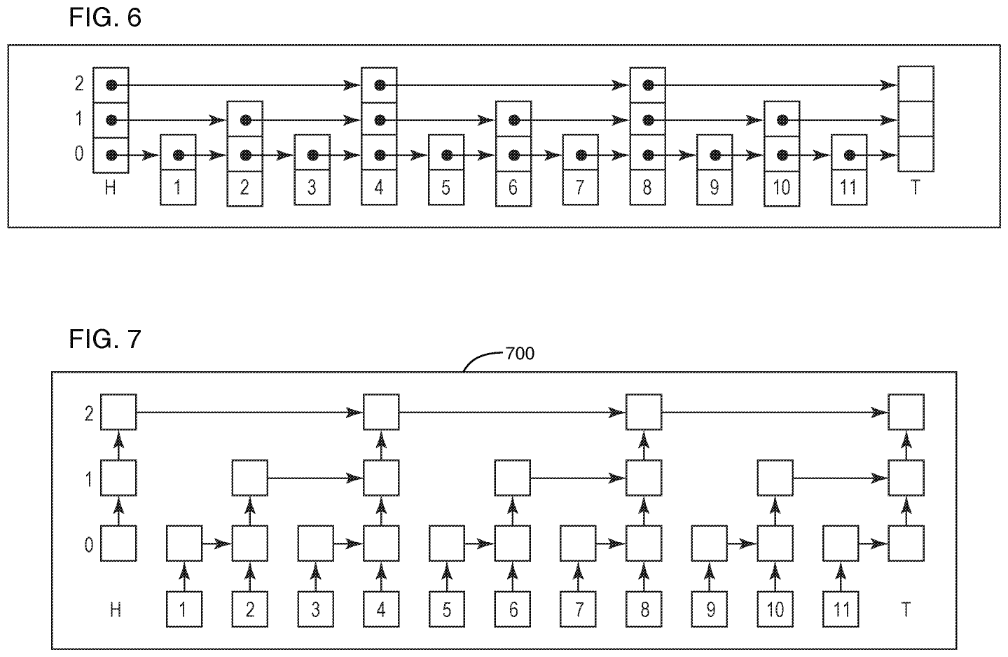

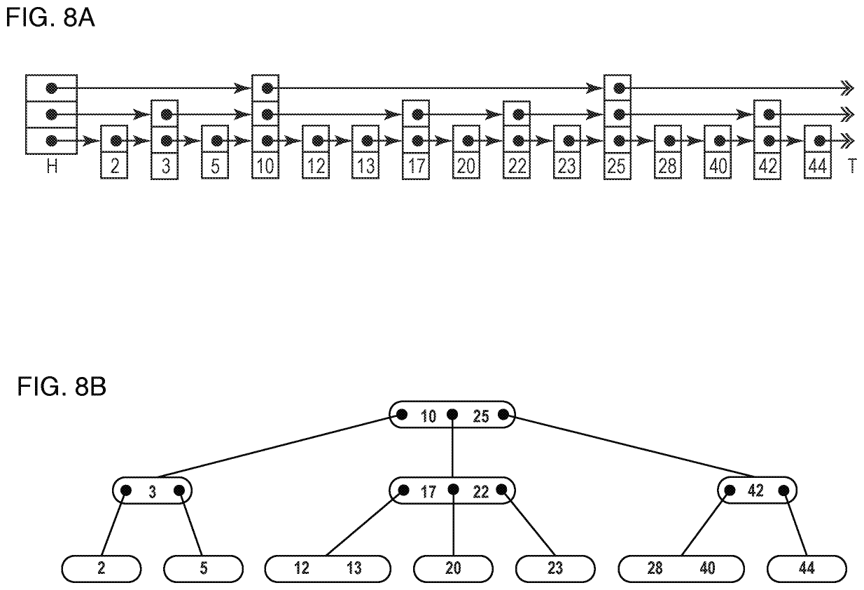

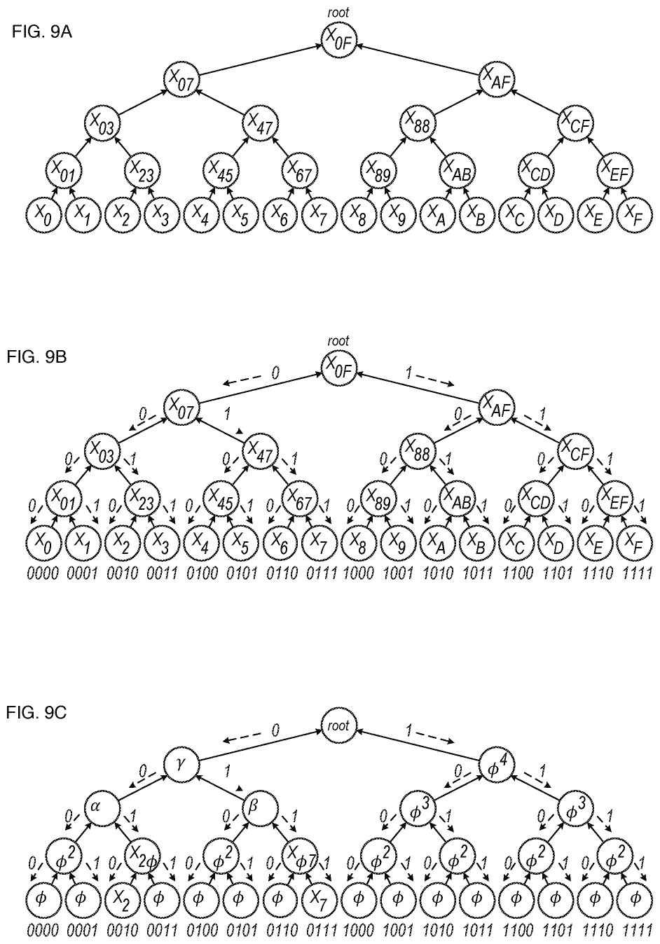

The previously illustrated embodiments of the DSV system are done using Merkle trees. An alternative uses skip lists (see https://www.cs.cmu.edu/˜ckingsf/bioinfo-lectures/skip lists.pdf) as a replacement for at least the Mutation Log Merkle tree. This option is illustrated in FIGS. 6 and 7. The skip list 700 begins with a header H; the highest-indexed value is the tail T. In FIG. 7, I and J are the “past” and K and L the “future” siblings on the shortest path from 6 to Z, with Z being the equivalent to the root in Merkle tree. FIGS. 8A and 8B illustrate a 1-2 skip list, and its corresponding 2-3 tree, both of which are known concepts. One advantage of a skip list over a conventional linked list is that a skip list allows for insertions within the data structure, that is, it does not limit additions to being appended at either end.

### Use of Encryption

If the data needs to be kept secret from the entity hosting the DSV server, the Mutation Log entries and the State Tree can be encrypted by the customer organization. The encryption/decryption keys may then be held by the customer. One method of deriving keys is to hold the keys in the form of a Merkle tree with the root of the tree holding a key derived from the process ID (explained above). Further, child nodes may derive more keys based on the root key above. Any general-purpose key derivation function may be used. The key would need to be shared with the auditor, or, alternatively, another level of encryption can be added to encrypt using the auditor's keys.

The DSV server digitally signs all Tree Head roots that it publishes. These signatures may be time-stamped, for example, by using KSI. This time stamping would ensure the following:

If the server's key were to ever leak, any future signatures with the same key could be automatically invalidated by the lack of a pre-leaking date timestamp. (The timestamp would also be included in gossip, as it is part of data that is necessary to authenticate the server's signature.) Thus, the leaked key could not be used to falsely implicate the server for split view.

That signature timestamp would also necessarily cover all the data in DSV (because the server's signature would naturally cover all that data).

### Sparse Merkle Tree (SMT)

For some data structures used in embodiments, a hash tree structure known as a “Sparse Merkle Tree” (SMT) is particularly advantageous. The structure and characteristics of an SMT will now be summarized, for completeness, followed by an explanation of how SMTs may be used in embodiments.

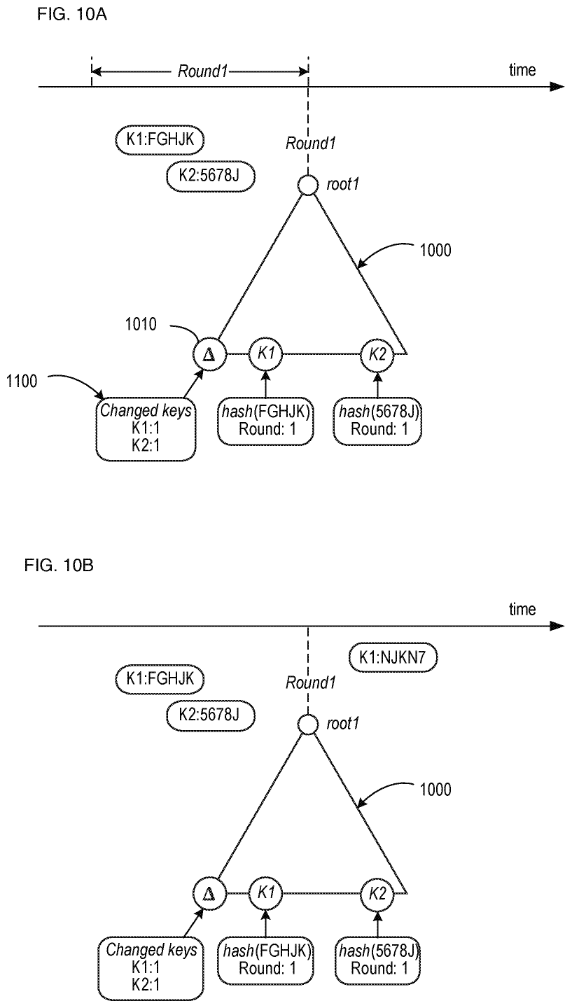

See FIG. 9A, which illustrates a very simple, 16-leaf (lowest level input) Merkle tree. In this example, lowest level nodes have values x0, x₁, . . . , x_{F}, which themselves may be functional transformations or combinations of any data set(s). In a binary tree (higher degree trees operate similarly), the lowest level values are functionally combined pairwise (or n-wise, for higher degree trees) and iteratively “upward”, to form successively higher level node values until a single uppermost “root” value is computed. In a typical Merkle tree, the values are combined by cryptographic hashing (hash). In FIG. 9A, xᵢⱼ indicates the hash value reached by iterative, pairwise hashing of the lowest level values xᵢ . . . xⱼ. Thus, for example, x₀₁=hash(x₀|x₁)

x_{8B}=hash(x₈₉|x_{AB})=hash(hash(x₈|x₉)|hash(x_{A}|x_{B}))

x_{0F}=root=hash(x₀₇|x_{AF})=hash(hash(x₀₃|x₄₇|hash(x_{8B}|x_{CF}))= . . .

and so on, where “|” indicates concatenation.

The path in the tree from a leaf to the root may be defined by a vector of “sibling” values. Thus, given value x₆, for example, and the vector (x₇, x₄₅, x₀₃, x_{AF}), it is possible to recompute the sequence of hash functions that should, if all values are unchanged from the original, result in the root value x_{0F}.

FIG. 9B illustrates a “directed” Merkle tree, in which the inputs (“leaves”) are arranged in a specified order. Now view the tree from the “top”, that is, from the root node and label the “left” path downward from each node “0” and the “right” path downward from the node “1”. Thus, x₀₇, is in a “0” path, x_{AF} is in the “1” path, x₄₇ is in the “1” path down from x₀₇ and thus in a “01” path from the root (once left, then right). Viewed from the root node x_{0F} downward, “leaf” node corresponding to x_{B} is thus labeled (that is, is in the position) 1011, since its path from the root is right-left-right-right. The other lowest level nodes are labeled accordingly.

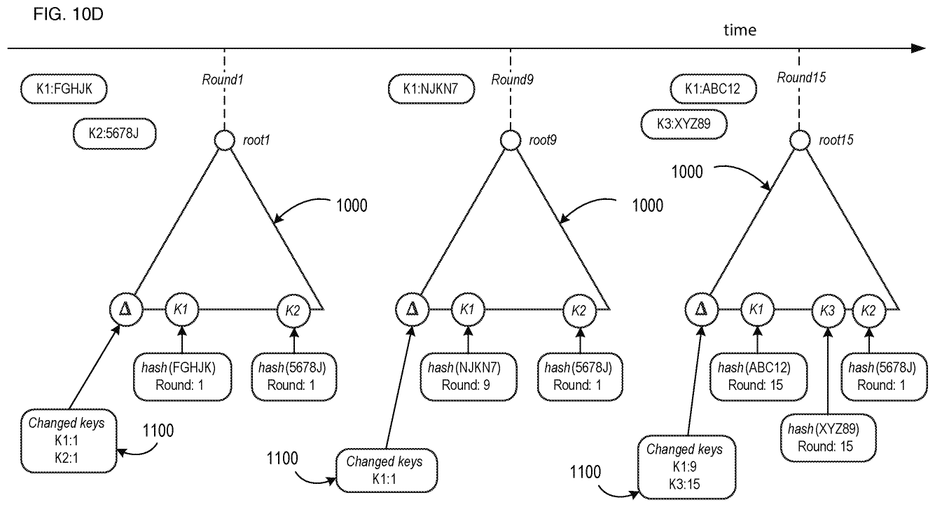

The simple Merkle tree illustrated in FIGS. 9A-90 has 2⁴=16 leaves, such that there are four “levels” or iterations of hash calculations (n+1 total levels of nodes) up to the root, such that each position can be represented with a four-digit binary number, corresponding to its path from the root. A tree that has a leaf position for all the possible inputs that could be formed from a 256-bit data word would thus have 256 levels of calculation and would need only a single 256-bit word to identify its leaf position in the tree. It would have 2²⁵⁶ leaves, corresponding to more than 10⁷⁷ values, which is at most a few orders of magnitude smaller than the standard estimates of the number of atoms in the entire observable universe. To actually construct a Merkle tree with a leaf for each possible value of a 256-bit word is therefore impossible. FIG. 90 illustrates a data structure—a “sparse” Merkle tree— that makes this theoretical task practically tractable in most cases.

In embodiments, the value that is assigned or computed (such as via hashing) for an object, such as a process, is the “key” which is used to determine which leaf of an SMT the current value associated with the object is to be assigned to. In the greatly simplified example of FIGS. 9A-9C, if the key (derived, for example, from unique identifiers) for an object whose current value is V is 0111, then the value V (or its hash or other encoding, with or without additional metadata) would be assigned as x7.

In FIG. 9C, which again is greatly simplified for the sake of illustration, only two of the possible 16 leaves (x₂ and x₇) have been assigned values; the remaining “empty” nodes' values are any chosen “null” value, indicated by the symbol Ø. Since Ø is known, so too will be any chain of hash functions of combinations (such as binary) of Ø. In the figure, Øⁿ indicates pairwise hashing of Ø values to the n'th level of the tree. Thus, Ø³=hash(Ø²|Ø²)=hash(hash(Ø|Ø)|hash(Ø|Ø)), and so on.

Now assume that the leaf values represent all the 16 possible values of a 4-bit binary word, that is, 0000, . . . , 1111, and that one wishes to determine if the node in position 0001 is “used”, that is, contains a non-null value. Using the convention chosen for this example, the value 0001 corresponds to downward traversal left-left-left-right from the root, which leads from the node root, to the node marked γ, to the node marked α (whose “sibling” node is marked β) and then to a node whose value is Ø². At this point, however, there is no need to examine the tree further, since a node value of Øⁿ indicates that there is no node junior that that node that has a non-null value. Thus, in this case, traversing the tree to the Ø² is sufficient to prove that no value has been entered into the data structure corresponding to leaf position 0001. This also means that it is not necessary to allocate actual memory for a value at position 0001 until it is necessary to store a non-null value in that node.

But now assume that one wishes to determine if any leaf has a non-null value in positions 1000 to 1111. Since the highest order bit for all of these is a “1”, the first step in the tree traversal is to the right, and the first node in that path has the known value Ø⁴, which indicates that no leaf value in any path below that node has a non-null value. There is no need to examine the tree further.

In the very simple example illustrated in FIGS. 9A-9C, the tree has only 2⁴=16 leaves and only two, that is, ⅛ the total, are non-null. Assume however that the tree leaves are to correspond to all 2²⁵⁶ possible values of a 256-bit data word, and that a new leaf value is generated every second for an entire year. This would correspond to a bit more than 3.15×10⁷ leaf values in the year, which is still an “occupancy” rate on the order of 10⁷/10⁷⁷=10⁻⁷⁰, which is of course very small. Almost all of the tree will have nodes corresponding to null values, hence, the concept of “sparseness”. This means that almost all searches for the existence of a non-null leaf value will be able to end after examining only a relatively small number of path values. Conversely, this also means that it will take little searching to determine if a leaf value is null: as soon as a search path reaches an Øⁿ node, the result is given.

### Generalized Embodiment

In general, embodiments include:

At least one Verifiable Data Structure (VDS) such as the Verifiable Map, such as a sparse Merkle tree, which forms a trust anchor. A VDS may be a data structure whose operations can be carried out even by an untrusted provider, but the results of which a verifier can efficiently check as authentic. In one embodiment, the VDS may be implemented using any known key-value data structure. In one embodiment, the preferred key-value data structure is a sparse Merkle tree in which the key indicates the “leaf” position in the tree, with the associated data value forming the leaf value itself. As just a few example, the key for a real estate registry could be the property ID, with owner information as the corresponding value; the key in a voter registry could be a voter registration number plus, for example, a personal identifier such as a national ID number, with the actual voter information as values; and in a VAT registry, invoice numbers could form keys, with the invoice values being the corresponding values.

Verifiable Log of Registry Changes (VLORC), which is a data structure that enables auditing and can indicate the most recent state of tracked objects. The VDS and VLORC may be implemented within the same central/administrative server.

Verifiable State Machine (VSM), which forms a registry for object state. The State Tree described above is an example of such a data structure. The VSM may be stored and processed in any server that is intended to keep the central state registry.

Proofs, which may be held by users, and which comprise digital receipts (such as signatures) of data that has been submitted for entry in the various data structures. For tree structures such as a SMT, the set of sibling values from a leaf to the root may form a proof. The root of the SMT may in turn be published in any irrefutable physical or digital medium such that any future root value presented as authentic can be checked against the published value. In general, there will be a new root for each aggregation round, that is, for each time period during which leaf values may be added or changed.

To better understand what the different structures accomplish, consider the use case of voter registration. In many jurisdictions, such as in most in the USA, a prospective voter must apply for entry into the voter roll, that is, registry, associated with a particular election district. Assume that a prospective voter wishes to submit an application for voter registration. The application (with its data), and the identity of the prospective voter, may be represented in digital form in any known manner and may be associated with some identifier, such as a hash of all or part of its contents (along with any chosen metadata), which may form a key. Let hash1 indicate the representation of the initial state of the application, for example, the hash value at the time of submission. hash1 may then be entered as a “leaf” value in the VDS), and thus be bound to the root hash value of that tree for the respective aggregation time.

At the same time, a representation of the state “Applied for” may be entered into VSM. As part of the processing of the application, the application may be approved, which may be registered in the VSM as a change of the corresponding entry to “Registered”. This will also cause a change of the hash path from the new entry up to the root of the VSM. Either the user may then be given proofs of VDS and VSM entry (hash paths or other signatures), or these may be combined and signed as a unit. The VLORC may then, for example, register the time at which the application state changed. The proof in the VLORC may then also be returned to the user if desired.

### Verifiable Log of Registry Changes (VLORC)

For all of the embodiments and use cases described above, certain issues of verifiability may arise, such as, without simply trusting the registry:
How does a user, auditor, etc., know that the currently indicated state is in fact the most recent?
What proves that the state of an object was not changed by a user or intermediary, and then secretly changed back, that is, how can one prove that a “flip flop” attack has not occurred?
How can one efficiently find changes associated with one key out of the potentially very large number of keys?

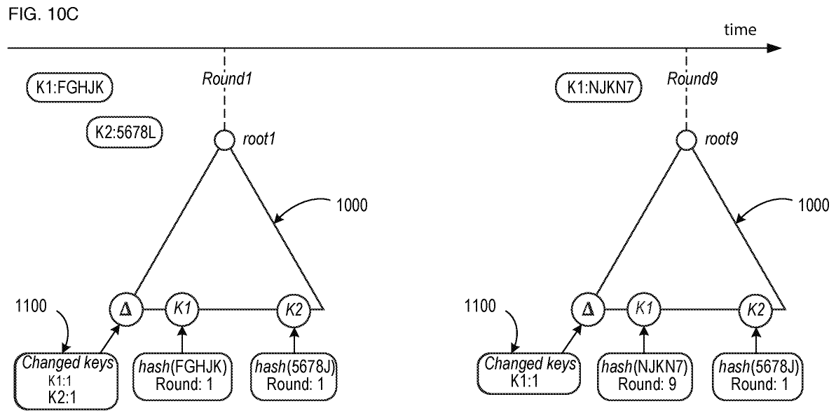

The VLORC addresses these questions. See FIGS. 10A-10D, in which a “triangle” 1000 represents, in simplified form, a sparse Merkle tree in which the current values of the data objects being tracked are recorded as leaves. Assume by way of simple example (FIG. 10A) that there are two data objects being tracked and that their keys are K1 and K2, respectively. As mentioned earlier, these keys could be computed as hash values of all of part of the data/metadata representing the state of the objects, which may be chosen in any suitable and preferred manner. For example, the personal ID of an account holder and/or the account number might be hashed to form a key, and the current balance could be the state of the account. As another example, the serial number of a product might be hashed (or otherwise encoded) to form a key for a product going through various stages of a manufacturing process, and data such as what manufacturing step is being completed, which worker or machine is involved, measurements, etc., might, after being hashed together, form the current value. As still another example, an official property or vehicle designation could be hashed to form a key, and the current title owner could be the associated value.

Assume a DSV instance that operates in rounds, that is, periods during which values are accumulated and a new root value of the SMT 1000 is computed. The length of each round may be determined by the system designer according to what types of data objects are to be tracked. For example, in a manufacturing process for large products, or changes of land ownership in a relatively small jurisdiction, changes may not happen rapidly, and a rounds could last several seconds or minutes or even longer. If all the accounts receivable of a large enterprise are to be tracked, however, or all financial transactions relating to many accounts, then more frequent rounds may be preferable. It is not necessary for rounds to be of the same length, although this will often be most convenient for the sake of bookkeeping. Also, if the DSV instance is to be synchronized with another infrastructure such as KSI, for example for the purpose of generating timestamped signatures, then it will generally be advantageous to arrange at least the time boundaries of DSV rounds to correspond to the time boundaries of KSI accumulation/calendar periods.

Assume by way of example (FIG. 10A) that the first object, whose key is K1, has an initial state value of FGHJK, that the second object, whose key is K2, has an initial state value of FG5678J, and that these initial values arise during a DSV round Round1. As explained above, the bits of the values of K1 and K2 may be used to determine a leaf position in the SMT 1000. This is shown in FIG. 10A. In many cases, the “raw” value of the state data may be entered directly as part of the leaf value; in others, it is preferable to conceal the raw state data by some encoding, such as by hashing. Thus, as shown in FIG. 10A, the value assigned to the SMT leaf at the position corresponding to K1 is hash(FGHJK); an indication (Round:i) that this value has been entered during Round1 is preferably also included as a value within the K1 SMT leaf. Likewise, hash(5678J) and Round:1 are entered at the K2 SMT leaf position.

One leaf of the SMT 1000 is chosen to be a “Key change” or “Delta” (Δ) leaf 1010. The value of the Δ leaf is a function of an indication of when the most recent previous change has been made relating to any non-null leaf that is changed from null to non-null in the current round. Let Ki:n indicate that key i most recently changed (or was first registered, if not previously) in round n. Thus, since the state corresponding to keys K1 and K2 changed in Round1, the Δ leaf encodes K1:1 and K2:1.

Note that initial entry of a key value forms a special case: the value n will be the same as the round in which the instance of the structure 1100 is found. In other words, since K1:1 and K2:1 are indicated in the structure 1100 and A leaf 1010 of the SMT 1000 for Round1, one can know that these are initial entries. Other indicators of initial entry of a key value may also be chosen, however, as long as they unambiguously indicate in which round the values are first registered in the SMT 1000. For example, in FIG. 100, the values for K1 and K2 in the Changed keys data structure could be 0, that is, K1:0 and K2:0 to indicate initial registration; an auditor will then be able to see that this has been assigned in Round1 anyway.

The information Ki:n for all i and n may be contained in any chosen data structure 1100. Since Ki will typically not directly reveal what data object it corresponds to, this structure may be revealable, which will also aide in auditing. A simple table (such as a hash table) or array may then be used as the Changed keys data structure, arranged in any preferred order. Another option for the data structure 1100 is yet another sparse Merkle tree, whose root value is passed to the SMT 1000 to be the value of the Δ leaf. The value n may then be assigned as the value of the leaf at the position corresponding to the key value Ki. As still another option, the Changed keys data structure could be configured as a skip list, which, as mentioned above, allows for insertion and is relatively efficient to search.

Assume (FIG. 10B) now that the state of the object whose key is K1 changes from FGHJK to NJKN7 in a subsequent round, for example, Round9. As FIG. 10C shows, hash(NJKN7) and an indication of Round: 9 will then be associated with SMT leaf position K1. The previous value of leaf K1 indicated that K1 had received its value in Round1, so the “Changed keys” data structure 1100 for round 9 lists that K1:1, indicating that the most recent previous change in the leaf corresponding to K1 happened in Round1. If an auditor then examines the Changed keys data structure 1100 for Round1, the auditor will see that K1:1, that is, the same as the round number, which may be the indication that this was initial entry of a non-null value in position K1.

In the illustration, the SMT 1000 leaf K2 value has not changed since Round1, so this leaf value remains hash(5678J), with an indication of Round 1.

Now assume (FIG. 10D) that, in Round 15, the object whose key is K1 again has a change of state, to ABC12, and that a new object, whose key is K3, with a value XYZ89, is to be registered for the first time in the system. In this round, leaves at positions K1 and K3 are thus changing, whereas K2 still remains the same. The Changed keys data structure for Roundly therefore indicates K1:9, since the most recent previous change to leaf K1 happened in Round 9, and K3:15, since this is the most recent change (which also is the current round, indicating here that this is an initial registration).

For each round, the root value (root1, . . . , root9, . . . , root15, . . . ) of the SMT 1000 is preferably immutably registered, for example, by entering it directly into a blockchain, or by submitting it as an input value (leaf) of the KSI signature infrastructure, which would then have the advantage of tying each round's root value to a calendar time.

Whenever a root value of a hash tree is generated, such as the SMT 1000, a proof is preferably returned to the user, and/or otherwise maintained for another entity, such as an auditor. The proof may be the parameters of the leaf-to-root hash path. If the root of one tree (such as SMT 1000) is used as an input leaf to a higher-level tree, then the proof may be extended up to the higher level root and, ultimately, in the cases in which the KSI infrastructure is used to sign and timestamp values, all the way to a published value that will also be available to an auditor.

Now again refer to FIG. 10D, and assume that an auditor wishes to track state changes relating to the object whose key value is K1 and that time has progressed to some period Roundj, where j≥15. If the K1 leaf value has not changed since Round15, then “Round15” will still be indicated in the K1 leaf of the SMT 1000 for Roundj, along with the value hash(NJKN7) (or even NJKN7, if there was no need to conceal this data and it otherwise conforms to whatever formatting requirements have been chosen for SMT leaves). The auditor may then directly refer to the SMT for Round15, where the auditor will be able to consult the Changed keys data structure 1100 and see that the previous change to K1 was in Round9. The auditor may then examine the SMT 1000 and Changed keys data structure 1100 for Round9, where the K1 value was hash(NJKN7), and also see in the Changed keys data structure than K1 was previously changed in Round1. Continuing this procedure, the auditor may examine the SMT for Round1, wee that K1 was then hash(FGHJK) and that, since the Changed keys entry is also Round1, there is no earlier registration for K1.

The SMT 1000 and Changed keys data structure 1100 for each round may be stored and made available by the central administrative server, or by another other entity. Especially if the SMT 1000 leaves do not contain “raw” client data, but rather only hashes, the SMT 1000 will not reveal any confidential client information. Note that new proofs are preferably generated for each value added to or changed in the leaves of the SMT 1000, but need not be regenerated for unchanged leaves—if the value of a leaf has not changed for some time, then the auditor may check the proof at the time of most recent change, which the auditor will be able to find by going “backwards” in time using the Changed keys data structure 1100. Clients preferably store all proofs for “their” respective state values (that is, SMT 1000 leaves) so that they may be presented to auditors; alternatively, or in addition, proofs may be submitted to any other controlling entity for storage, including the auditing entity itself.

In the cases in which hash values of data objects are registered, such as hash(FGHJK) instead of FGHJK directly, the entity being audited will reveal the “raw” values to the auditor. As long as the hash function used in the SMT structures is known (for example, consistently SHA-256 or the like), then the auditor will also be able to compute its hash value, without the raw data having to be revealed to any other entities. The Changed keys data structure 1100 may, however, for the sake of transparency, be revealed, since it need not contain any “raw” data that identifies any particular user, account, data object (such as a unit of digital currency or other negotiable instrument), etc.

Rather than having a single Changed keys data structure, it would also be possible for clients to maintain respective Changed keys data structures containing information only for their own keys Kj. The roots or other accumulating values of these structures may then be combined by the administrative sever that maintains the SMT 1000 in any known manner, such as by aggregating them in yet a separate SMT or other hash tree, whose root value forms the Δ leaf value. The clients should then retain proofs from “their” entries (“leaves”) to roots, and up to the roots of at least one tree maintained by the administrative server, such as SMT 1000, to prevent any later alteration.

The central, administrative server should store the VLORC SMT 1000 for each round. Assume that a client being audited with respect to the data object whose key is K1 reports a current value of ABC12 to the auditor. The auditor may then contact the administrative server and download the most recent VLORC SMT 1000, compute hash(ABC12) and see that it matches the current value for the K1 leaf. The auditor will then also see the “linkage”, via the Changed keys data structure, back to Round15, to Round9, and to Round1, along with the respective values at those times (the auditor may, for example, request “raw” data from the client). Note that, since other metadata may be entered into a leaf value in addition to the hash ( . . . ) and Round:j data, the auditor will be able to confirm this as well from the proof generated when any change was registered. In short, by following the values in the Changed keys data structure 1100 iteratively “backwards” in time, an auditor may track the entire change history of a data object back to the round during which it was first registered in the SMT 1000.

The auditor may then also recompute the proofs associated with the current K1 and previous K1-associated values and confirm that this leads to the correct root values. This ensures that the SMT structure 1000 itself was not improperly altered.

In the embodiment illustrated in FIGS. 10A-10D, the leaves of the SMT 1000 include information not only about the current value associated with each non-null leaf (corresponding to a key), but also the round in which it acquired its current value. If rounds are coordinated with time, then the SMT 1000 is also encoding the time of changes. As such, the single SMT 1000 acts as both the VDS and VSM. It would also be possible to use two separate SMT (or other) data structures for these two functions, which could be held by separate entities. As long as the key values Ki are used to point to SMT leaves in the same relative positions within each structure, an auditor would still be able to easily track both the values and transitions of each registered object, albeit with two queries of SMIs instead of one.

1. A method for auditably tracking data objects, comprising:
in a first data structure (1000), aggregating inputs by rounds (Round1, Round9, Round15, Z) and, at the end of each corresponding round, computing a highest level value (root1, root9, root15) of the first data structure;
at a position within the first data structure (1000) corresponding to a respective unique key (Ki) computed for each respective data object, setting as a respective input value an indication of which round during which a state value representing the respective data object was most recently changed;
for each input of the first data structure that is changed during each round, storing in a second data structure (1100) an indication of during which previous round each respective changed input was most recently changed; and
for each round, computing a representative value of the second data structure and storing the representative value as an input (1010) in the first data structure;
whereby a change history of each data object may be determined by iteratively examining a state of the first data structure (1000) backwards in time according to the according to the indications in the second data structure (1100) corresponding to the respective data object.

2. The method of claim 1, further comprising:
determining a respective state value corresponding to at least one tracked characteristic of each data object; and
upon each change of the at least one tracked characteristic and corresponding updated state value for any one of the data objects, storing a representation of the respective state value in the first data structure (1000) at the position corresponding to the respective key of the data object.

3. The method of claim 2, in which the first data structure (1000) is a first sparse Merkle tree (SMT), said highest level value being a root of the first SMT.

4. The method of claim 3, further comprising, for each round, computing and associating with each input that has changed a proof comprising a set of sibling values enabling recomputation through the first SMT from the input to the root.

5. The method of claim 4, further comprising inputting the root of the first SMT as an input to a timestamping signature infrastructure.

6. The method of claim 1, in which the second data structure (1100) is a second sparse Merkle tree (SMT) and computing the representative value as a root of the second SMT.

7. The method of claim 1, in which the first data structure (1000) is a skip list.
